(19) United States
(12) Patent Application Publication
(10) Pub. No.: US 2023/0370785 A1
(43) Pub. Date: Nov. 16, 2023

(54) Silicon Based Microphone Apparatus And Electronic Device

(71) Applicant: GMEMS Tech Shenzhen Limited, Shenzhen (CN)

(72) Inventors: Yunlong Wang, Shenzhen Guangdong (CN); Guanghua Wu, Shenzhen Guangdong (CN); Xingshuo Lan, Shenzhen Guangdong (CN)

(73) Assignee: GMEMS Tech Shenzhen Limited, Shenzhen Guangdong (CN)

(21) Appl. No.: 18/026,235

(22) PCT Filed: Feb. 7, 2021
(86) PCT No.: PCT/CN2021/075872

§ 371 Date: Mar. 14, 2023

(30) Foreign Application Priority Data
Sep. 17, 2020 (CN) 202010981353.X

(51) Int. Cl. H04R 19/04; H04R 19/00

(52) U.S. Cl. CPC H04R 19/04; H04R 19/005

(57) ABSTRACT

Embodiments of the present application provide a silicon based microphone apparatus and an electronic device. The silicon based microphone apparatus comprises: a circuit board provided with at least one sound inlet hole; a shielding cover covering one side of the circuit board to form an acoustic cavity; at least two differential silicon based microphone chips arranged on one side of the circuit board and located within the acoustic cavity, back cavities of some differential silicon based microphone chips being communicated with the sound inlet holes in one-to-one correspondence; and a separator located within the acoustic cavity and used for separating the acoustic cavity into sub-acoustic cavities corresponding to the back cavities of at least some adjacent differential silicon based microphone chips. According to the embodiments of the present application, a sound pickup structure comprising at least two differential silicon based microphone chips is used, so that noise reduction can be achieved and the quality of an output audio signal can be improved; the separator in the acoustic cavity can effectively reduce interference caused by sound waves on other differential silicon based microphone chips, can effectively improve the sound pickup precision of the differential microphone chips, and can further improve the quality of the audio signal output by the silicon based microphone apparatus.

### CROSS-REFERENCE TO RELATED APPLICATION

This application claims priority to Application No. 202010981353X, filed on Sep. 17, 2020 in the China National Intellectual Property Administration (CNIPA), the disclosure of which is herein incorporated by reference in its entirety.

### TECHNICAL FIELD

The present disclosure relates to a technical field of acoustic-electrical conversion, and in particular, the present disclosure relates to a silicon-based microphone apparatus and an electronic device.

### BACKGROUND

When an existing silicon-based microphone acquires a sound signal, a silicon-based microphone chip in the microphone generates a vibration due to a sound wave acquired therefrom, and the vibration brings about a variation in capacitance that may form an electrical signal, thereby converting the sound wave into an electrical signal to be output. However, the noise processing of the existing microphone may not be ideal, affecting the quality of the output audio signal.

### SUMMARY

In view of the shortcomings of the existing method, a silicon-based microphone apparatus and an electronic device are proposed to solve the technical problem that the existing microphone has unsatisfactory noise processing and the quality of the output audio signal is affected in the prior art.

In a first aspect, an embodiment of the present disclosure provides a silicon-based microphone apparatus including: a circuit board provided with at least one sound inlet hole; a shielding housing covering one side of the circuit board to form a sound cavity; at least two differential silicon-based microphone chips disposed at the one side of the circuit board and located in the sound cavity, portion of the at least two differential silicon-based microphone chips each having a back cavity communicated with the respective sound inlet hole; and a separation member located in the sound cavity and separating the sound cavity into sub-sound cavities corresponding to back cavities of at least portion of the differential silicon-based microphone chips adjacent thereto.

In a second aspect, an embodiment of the present disclosure provides an electronic device including the silicon-based microphone apparatus described in the first aspect.

In some embodiments of the present disclosure, the silicon-based microphone apparatus adopts a pickup structure of at least two differential silicon-based microphone chips, and each of portion of differential silicon-based microphone chips has a back cavity communicated with the respective sound inlet hole, such that external sound waves and the noise from the electronic device itself may act on the differential silicon-based microphone chips, and the differential silicon-based microphone chips generate a mixed electrical signal of sound electrical signal and noise electrical signal. The back cavities of the other portion of the differential silicon-based microphone chips may be closed by the circuit board, such that most of the external sound waves may be prevented from entering, the noise from the electronic device itself may act on the differential silicon-based microphone chips, and the differential silicon-based microphone chips generate noise electrical signal. Further processing is performed on the mixed electrical signal and the noise electrical signal by a subsequent means, which may achieve noise reduction and improve the quality of the output audio signal.

In some embodiments of the present disclosure, the sound cavity of the silicon-based microphone apparatus is formed by covering one side of the circuit board with the shielding housing, and the separation member separates the sound cavity into sub-sound cavities corresponding to back cavities of at least portion of the differential silicon-based microphone chips adjacent thereto. In this way, it is possible to effectively reduce the probability or intensity of sound waves entering the back cavity of each differential silicon-based microphone chip to continue to propagate in the sound cavity of the silicon-based microphone apparatus, reduce the interference of the sound waves on other differential silicon-based microphone chips, and effectively improve the pickup accuracy of each differential microphone chip, thereby improving the quality of audio signals output by the silicon-based microphone apparatus.

Additional aspects and advantages of the present disclosure will be set forth partially in the following description, and would be apparent from the following description, or learned by practice of the present disclosure.

### BRIEF DESCRIPTION OF DRAWINGS

The above and/or additional aspects and advantages of the present disclosure will become apparent and readily understood from the following description of embodiments, taken in conjunction with the accompanying drawings, in which:

FIG. 1 is a schematic structural diagram of a silicon-based microphone apparatus according to an embodiment of the present disclosure;

FIG. 2 is a schematic structural diagram of a differential silicon-based microphone chip in a silicon-based microphone apparatus according to an embodiment of the present disclosure;

FIG. 3 is a schematic structural diagram of an electrical connection between two differential silicon-based microphone chips in a silicon-based microphone apparatus according to an embodiment of the present disclosure; and

FIG. 4 is a schematic structural diagram of another electrical connection between two differential silicon-based microphone chips in a silicon-based microphone apparatus according to an embodiment of the present disclosure;

### IN DRAWINGS

100: circuit board; 110: sound inlet hole;
200: shielding housing; 210: sound cavity;
300: differential silicon-based microphone chip; 300a: first differential silicon-based microphone chip; 300b: second differential silicon-based microphone chip;
301: first microphone structure; 301a: first microphone structure of first differential silicon-based microphone chip; 301b: first microphone structure of second differential silicon-based microphone chip;
302: second microphone structure; 302a: second microphone structure of first differential silicon-based microphone chip; 301b: second microphone structure of second differential silicon-based microphone chip;
303: back cavity; 303a: back cavity of first differential silicon-based microphone chip; 303b: back cavity of second differential silicon-based microphone chip;
310: upper back plate; 310a: first upper back plate; 310b: second lower back plate;
311: upper airflow hole;
312: upper back plate electrode; 312a: upper back plate electrode of first upper back plate; 312b: upper back plate electrode of second upper back plate;
313: upper air gap;
320: lower back plate; 320a: first lower back plate; 320b: second lower back plate;
321: lower airflow hole;
322: lower back plate electrode; 322a: lower back plate electrode of first lower back plate; 322b: lower back plate electrode of second lower back plate;
323: lower air gap;
330: semiconductor diaphragm; 330a: first semiconductor diaphragm; 330b: second semiconductor diaphragm;
331: semiconductor diaphragm electrode; 331a: semiconductor diaphragm electrode of first semiconductor diaphragm; 331b: semiconductor diaphragm electrode of second semiconductor diaphragm;
340: silicon substrate; 340a: first silicon substrate; 340b: second silicon substrate;
341: via hole;
350: first insulating layer;
360: second insulating layer;
370: third insulating layer;
380: wire;
400: control chip; and
500: separation member.

### DETAILED DESCRIPTION OF EMBODIMENTS

The present disclosure is described in detail below, and examples of embodiments of the present disclosure are illustrated in the accompanying drawings, in which the same or similar reference numerals throughout refer to the same or similar components, or components having the same or similar functions. Also, detailed description of the well-known technologies is omitted if it is not necessary for illustrating features of the present disclosure. The embodiments described below with reference to the accompanying drawings are exemplary and are only used to explain the present disclosure, but not to be construed to be limiting thereof.

It is to be understood by those skilled in the art that all terms (including technical and scientific terms) used herein have the same meaning as commonly understood by one of ordinary skill in the art to which the present disclosure belongs unless otherwise defined. It is further to be understood that terms, such as those defined in a general dictionary, should be understood to have meanings consistent with meanings thereof in the context of the prior art, and should not be interpreted in an idealistic or overly formal meaning unless specifically defined as herein.

It is to be understood by those skilled in the art that singular forms “a”, “an”, and “the” used herein may also include plural forms unless expressly stated. It is to be further understood that the word “includes”, “including”, “comprises” or “comprising” used in the specification of the present disclosure refers to presence of the stated feature, integer, element and/or component, but does not exclude presence or addition of one or more other features, integers, elements, components and/or a combination thereof. It is to be understood that when an element is referred to as being “connected” or “coupled” to another element, it may be directly connected or coupled to the other element or intervening elements may also be present. Further, the “connect” or “couple” as used herein may include wireless connection or wireless coupling. As used herein, the term “and/or” includes all or any one and all combination of one or more of the associated listed items.

On the basis of research, inventors of the present disclosure found that, with the popularization of IOT (The Internet of Things) devices such as smart speakers, it is not easy for a user to use a voice command on a smart device that is issuing a sound, for example, to issue a voice command such as an interrupt command or an wake-up command, etc. to a smart speaker that is playing music, or to communicate by using a hands-free operation of a mobile phone. The user often needs to interrupt the playing music with a special wake-up word when getting as close to the IOT device as possible, and then perform human-computer interaction. In these typical voice interaction scenarios, since the IOT device is in use, it is playing music or making sound through the speaker, thereby causing the vibration of the body, and such vibration is picked up by the microphone on the IOT device, such that an effect of echo cancellation is not excellent. This phenomenon is particularly significant in smart home products which generate a louder internal noise, such as a mobile phone playing music, a TWS (True Wireless Stereo) headphone, a robot vacuum, a smart air conditioner, a smart kitchen ventilator and the like.

On the basis of research, inventors of the present disclosure further found that, when a silicon-based microphone apparatus having multiple microphone chips is used, noise reduction may be effectively realized. At the same time, inventors of the present disclosure noted that, if the sound energies received by the multiple microphone chips are inconsistent, the sound wave having higher energy may continue to propagate in the sound cavity of the silicon-based microphone apparatus, causing interference to other microphone chips (the smaller the volume of the sound cavity, the more obvious the interference), which will reduce the pickup accuracy of other microphone chips, and thus affect the quality of the audio signal output by the silicon-based microphone apparatus.

The silicon-based microphone apparatus and electronic device provided by the present disclosure are intended to solve the above technical problems in the prior art.

The technical solutions of the present disclosure and how to solve the above-mentioned technical problems by using the same are described in detail below with reference to detailed embodiments.

An embodiment of the present disclosure provides a silicon-based microphone apparatus, and the schematic structural diagram of the silicon-based microphone apparatus is shown in FIG. 1. The silicon-based microphone apparatus includes a circuit board 100, a shielding housing 200, at least two differential silicon-based microphone chips 300 and a separation member 500.

The circuit board 100 is provided with at least one sound inlet holes 110.

The shielding housing 200 covers one side of the circuit board 100 to form a sound cavity 210.

The at least two differential silicon-based microphone chips 300 are disposed at the one side of the circuit board 100 and are located in the sound cavity 210. Each of portion of the differential silicon-based microphone chips 300 has a back cavity 303 communicated with a respective sound inlet hole 110 in a one-to-one correspondence.

The separation member 500 is located in the sound cavity 210 and separates the sound cavity 210 into sub-sound cavities 210 corresponding to back cavities 303 of at least portion of the differential silicon-based microphone chips 300 adjacent thereto.

In the present embodiment, the silicon-based microphone apparatus employs a pickup structure of at least two differential silicon-based microphone chips 300. It is to be noted that the silicon-based microphone apparatus in FIG. 1 is only exemplified as having two differential silicon-based microphone chips 300.

Each of portion of the differential silicon-based microphone chips 300 has a back cavity 303 communicated with the respective sound inlet hole 110 in a one-to-one correspondence, such that external sound waves and the noise from the electronic device itself may act on the differential silicon-based microphone chips 300, and the differential silicon-based microphone chips 300 generate a mixed electrical signal of sound electrical signal and noise electrical signal.

The back cavities 303 of other portion of the differential silicon-based microphone chips 300 may be closed by the circuit board 100, such that most of the external sound waves may be prevented from entering, while the noise from the electronic device itself may act on those differential silicon based microphone chips 300, and those differential silicon-based microphone chips 300 generate a noise electrical signal.

Further processing is performed on the mixed electrical signal and the noise electrical signal by a subsequent means, which may achieve noise reduction and improve the quality of the output audio signal.

Moreover, the sound cavity 210 of the silicon-based microphone apparatus is formed by covering one side of the circuit board 100 with the shielding housing 200, and the separation member 500 separates the sound cavity 210 into sub-sound cavities 210 corresponding to back cavities 303 of at least portion of the differential silicon-based microphone chips 300 adjacent thereto. In this way, it is possible to effectively reduce the probability or intensity of sound waves entering the back cavity 303 of each differential silicon-based microphone chip 300 to continue to propagate in the sound cavity 210 of the silicon-based microphone apparatus, reduce the interference of sound waves on other differential silicon-based microphone chips 300, and effectively improve the pickup accuracy of each differential microphone chip 300, thereby improving the quality of audio signals output by the silicon-based microphone apparatus.

Optionally, the differential silicon-based microphone chips 300 are fixedly attached to the circuit board 100 through silica gel.

A relatively closed sound cavity 210 is enclosed between the shielding housing 200 and the circuit board 100. In order to shield the devices such as the differential silicon-based microphone chips 300 in the sound cavity 210 from suffering the electromagnetic interference, the shielding housing 200 may optionally include a metal housing, and the metal housing is electrically connected with the circuit board 100.

Optionally, the shielding housing 200 may be fixedly attached to one side of the circuit board 100 through solder paste or conductive glue.

Optionally, the circuit board 100 may include a PCB (printed circuit board) 100.

Optionally, the separation member 500 may adopt a structure having a single plate shape, a cylinder structure or a honeycomb structure.

In some possible embodiments, as shown in FIG. 1, the separation member 500 according to an embodiment of the present disclosure has one end extending toward the shielding housing 200 and the other end extending at least to a side of the differential silicon-based microphone chip 300 away from the circuit board 100.

In the present embodiment, one end of the separation member 500 extends toward the shielding housing 200, and the other end thereof extends at least to a side of the differential silicon-based microphone chip 300 away from the circuit board 100. In this way, the sub-sound cavities 210 having a certain degree of enclosure may be formed with the help of the structure of the shielding housing 200 and the differential silicon-based microphone chip 300 together with the separation member 500, and thus, the sound wave passing through the back cavity 303 of the differential silicon-based microphone chip 300 may be surrounded to a certain extent. Thus, it is possible to reduce the probability or intensity of the incoming sound waves continuing to propagate in the sound cavity 210 of the differential silicon-based microphone apparatus, reduce the interference of the sound waves to other differential silicon-based microphone chips 300, and effectively improve the pickup accuracy of each differential silicon-based microphone chip 300, thereby improving the quality of audio signals output by the silicon-based microphone apparatus.

Optionally, as shown in FIG. 1, the separation member 500 according to an embodiment of the present disclosure has one end attached to the shielding housing 200. That is, the sides close to the shield housing 200 of the adjacent sub-sound cavities 210 separated by the separation member 500 are completely separated, which may strengthen the separation between adjacent sub-sound cavities 210, further reduce the interference of the sound waves to other differential silicon-based microphone chips 300, and effectively improve the pickup accuracy of each differential silicon-based microphone chip 300, thereby improving the quality of audio signals output by the silicon-based microphone apparatus.

Optionally, the separation member 500 according to an embodiment of the present disclosure has the other end attached to one side of the circuit board 100. That is, the sides close to the circuit board 100 of the adjacent sub-sound cavities 210 separated by the separation member 500 are completely separated, which may strengthen the separation between adjacent sub-sound cavities 210, further reduce the interference of the sound waves to other differential silicon-based microphone chips 300, and effectively improve the pickup accuracy of each differential silicon-based microphone chip 300, thereby improving the quality of audio signals output by the silicon-based microphone apparatus.

In some possible embodiments, as shown in FIG. 1, the at least two differential silicon-based microphone chips 300 according to an embodiment of the present disclosure include an even number of the differential silicon-based microphone chips 300, and the back cavity 303 of one of every two differential silicon-based microphone chips 300 is communicated with the sound inlet hole 110.

In the present embodiment, in every two differential silicon-based microphone chips 300, the back cavity 303 of one differential silicon-based microphone chip 300 is communicated with external environment through the sound inlet hole 110 on the circuit board 100, and the back cavity 303 of the other differential silicon-based microphone chip 300 is enclosed by the circuit board 100.

Specifically, the back cavity 303a of a first differential silicon-based microphone chip 300a is communicated with the external environment through the sound inlet hole 110 on the circuit board 100, such that the external sound waves and the noise from the electronic device itself may act on the differential silicon-based microphone chip 300a, and the differential silicon-based microphone chip 300a generates a mixed electrical signal of sound electrical signal and noise electrical signal.

The back cavity 303b of a second differential silicon-based microphone chip 300b is enclosed by the circuit board 100, such that most of the external sound waves may be prevented from entering, the noise from the electronic device itself may act on the second differential silicon-based microphone chip 300b, and the second differential silicon-based microphone chip 300b generates a noise electrical signal.

The inventors of the application considered that the multiple microphone chips in the silicon based microphone apparatus need to cooperate to achieve noise reduction. To this end, the present disclosure provides one following possible implementation for the electrical connection of the differential silicon based microphone chips.

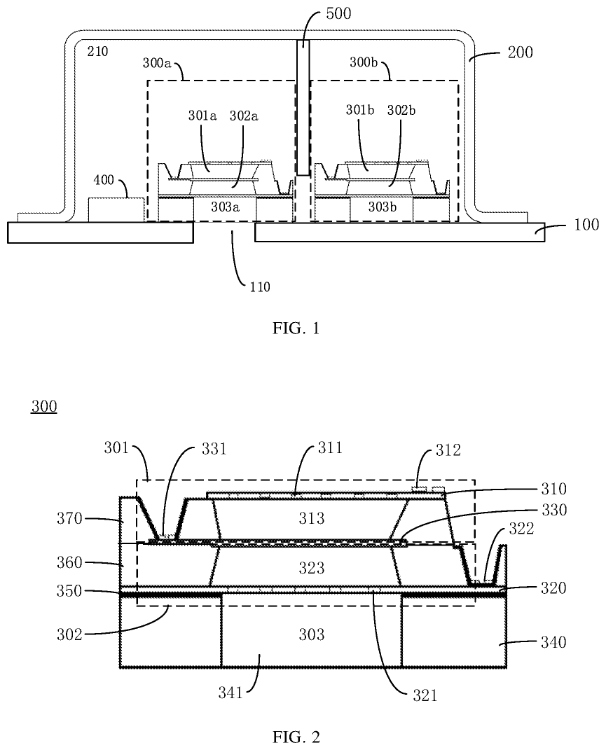

As shown in FIG. 2, in every two differential silicon based microphone chips 300 according to an embodiment of the present disclosure, a first microphone structure 301 of one differential silicon-based microphone chip 300 is electrically connected with a second microphone structure 302 of the other differential silicon-based microphone chip 300, and a second microphone structure 302 of the one differential silicon-based microphone chip 300 is electrically connected with a first microphone structure 301 of the other differential silicon-based microphone chip 300.

In the present embodiment, for the convenience of description, herein, a microphone structure far from the circuit board 100 in the differential silicon based microphone chip 300 is defined as the first microphone structure 301, and a microphone structure close to the circuit board 100 in the differential silicon based microphone chip 300 is defined as the second microphone structure 302.

Due to the effect of sound waves, the first microphone structure 301 and the second microphone structure 302 in the differential silicon-based microphone chip 300 may generate electrical signals with the same variation amplitude and opposite signs, respectively. Therefore, in an embodiment of the present disclosure, the first microphone structure 301a of the first differential silicon-based microphone chip 300a is electrically connected with the second microphone structure 302b of the second differential silicon-based microphone chip 300b, and the second microphone structure 302a of the first differential silicon-based microphone chip 300a is electrically connected with the first microphone structure 301b of the second differential silicon-based microphone chip 300b. Thus, the mixed electrical signal of sound electrical signal and noise electrical signal generated by the first differential silicon-based microphone chip 300a may be superimposed with the noise electrical signal having the same change amplitude and the opposite sign generated by the second differential silicon-based microphone chip 300b, so as to attenuate or counteract the homologous noise signal in the mixed electrical signal through physical noise reduction, thereby improving the quality of the audio signal.

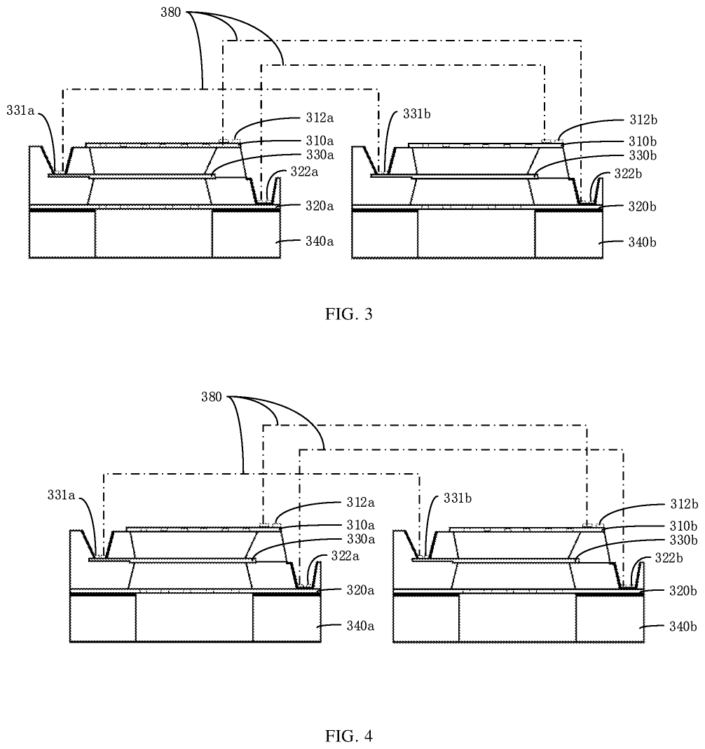

In some possible embodiments, as shown in FIG. 3, the differential silicon-based microphone chip 300 according to an embodiment of the present disclosure includes an upper back plate 310, a semiconductor diaphragm 330 and a lower back plate 320 disposed to be stacked and spaced apart from each other.

The upper back plate 310 and the semiconductor diaphragm 330 constitute a main body of the first microphone structure 301. The semiconductor diaphragm 330 and the lower back plate 320 constitute a main body of the second microphone structure 302.

Each of the upper back plate 310 and the lower back plate 320 has a portion provided with a plurality of airflow holes corresponding to the sound inlet hole 110.

Specifically, a gap, such as an air gap, may be provided between the upper back plate 310 and the semiconductor diaphragm 330, and between the semiconductor diaphragm 330 and the lower back plate 320.

For the convenience of description, herein, a back plate far from the circuit board 100 in the differential silicon based microphone chip 300 is defined as the upper back plate 310, and a back plate close to the circuit board 100 in the differential silicon based microphone chip 300 is defined as the lower back plate 320.

In the present embodiment, the semiconductor diaphragm 330 is shared by the first microphone structure 301 and the second microphone structure 302. The semiconductor diaphragm 330 may be implemented with a thinner structure with stronger toughness, and may be deformed and bent under action of the sound waves. Both the upper back plate 310 and the lower back plate 320 may be implemented with a structure having a thickness much larger than that of the semiconductor diaphragm 330 and a stronger rigidity, which is not easily deformed.

Specifically, the semiconductor diaphragm 330 and the upper back plate 310 may be arranged in parallel and separated by an upper air gap 313, thereby forming the main body of the first microphone structure 301. The semiconductor diaphragm 330 and the lower back plate 320 may be arranged in parallel and separated by a lower air gap 323, thereby forming the main body of the second microphone structure 302. It could be understood that an electric field (non-conduction) may be formed between the semiconductor diaphragm 330 and the upper back plate 310 and between the semiconductor diaphragm 330 and the lower back plate 320. The sound waves entering through the sound inlet hole 110 may contact the semiconductor diaphragm 330 after passing through the back cavity 303 and the lower air flow holes 321 in the lower back plate 320.

When the sound waves enter the back cavity 303 of the differential silicon-based microphone chip 300, the semiconductor diaphragm 330 may be deformed under the action of the sound waves. The deformation may cause the gaps between the semiconductor diaphragm 330 and the upper back plate 310 or the lower back plate 320 to be changed, which may bring about variation in capacitance between the semiconductor diaphragm 330 and the upper back plate 310, and variation in capacitance between the semiconductor diaphragm 330 and the lower back plate 320, and thus, the conversion of the sound waves into electrical signals is realized.

For a single differential silicon-based microphone chip 300, by applying a bias voltage between the semiconductor diaphragm 330 and the upper back plate 310, an upper electric field may be formed in the gap between the semiconductor diaphragm 330 and the upper back plate 310. Similarly, by applying a bias voltage between the semiconductor diaphragm 330 and the lower back plate 320, a lower electric field may be formed in the gap between the semiconductor diaphragm 330 and the lower back plate 320. Since polarity of the upper electric field is opposite to that of the lower electric field, when the semiconductor diaphragm 330 is bent up and down under the action of the sound waves, variation in capacitance of the first microphone structure 301 has the same amplitude as and the opposite sign to variation in capacitance of the second microphone structure 302.

Optionally, the semiconductor diaphragm 330 may be made of polysilicon materials, and the semiconductor diaphragm 330 has a thickness of no greater than 1 micrometer, thus the semiconductor diaphragm 330 may be deformed even under an action of relatively weak sound waves, and the sensitivity is relatively high. Both the upper back plate 310 and the lower back plate 320 may be made of a material with relatively strong rigidity and having a thickness of several micrometers. A plurality of upper airflow holes 311 are formed in the upper back plate 310 by etching, and a plurality of lower airflow holes 321 are formed in the upper back plate 320 by etching. Therefore, when the semiconductor diaphragm 330 is deformed by the action of the sound waves, neither the upper back plate 310 nor the lower back plate 320 may be affected to generate deformation.

Optionally, the gap between the semiconductor diaphragm 330 and the upper back plate 310 or the lower back plate 320 has a size of several micrometers, that is, in the order of micrometers.

In some possible embodiments, as shown in FIG. 3, every two of the differential silicon-based microphone chips 300 according to an embodiment of the present disclosure include a first differential silicon-based microphone chip 300a and a second differential silicon-based microphone chip 300b.

A first upper back plate 310a of the first differential silicon-based microphone chip 300a is electrically connected with a second lower back plate 320b of the second differential silicon-based microphone chip 300b to form a first signal path.

A first lower back plate 320a of the first differential silicon-based microphone chip 300a is electrically connected with a second upper back plate 310b of the second differential silicon-based microphone chip 300b to form a second signal path.

As described in detail above, in a single differential silicon-based microphone chip 300, variation in capacitance of the first microphone structure 301 and variation in capacitance of the second microphone structure 302 have the same amplitude and the opposite sign. Similarly, in every two of the differential silicon-based microphone chips 300, variation in capacitance at the upper back plate 310 of one differential silicon-based microphone chip 300 and variation in capacitance at the lower back plate 320 of the other differential silicon-based microphone chip 300 have the same amplitude and the opposite sign.

Therefore, in the present embodiment, by superimposing the mixed electrical signal of the sound electrical signal and the noise electrical signal generated at the first upper back plate 310a of the first differential silicon-based microphone chip 300a and the noise electrical signal generated at the second lower back plate 320b of the second differential silicon-based microphone chip 300b to form a first signal, the homologous noise signals in the mixed electrical signal may be attenuated or counteracted, thereby improving the quality of the first signal.

Similarly, by superimposing the mixed electrical signal of the sound electrical signal and the noise electrical signal generated at the first lower back plate 320a of the first differential silicon-based microphone chip 300a and the noise electrical signal generated at the second upper back plate 310b of the second differential silicon-based microphone chip 300b to form a second signal, the homologous noise signals in the mixed electrical signal may be attenuated or counteracted, thereby improving the quality of the second signal.

Specifically, an upper back plate electrode 312a of the first upper back plate 310a may be electrically connected with a lower back plate electrode 322b of the second lower back plate 320b through a wire 380 to form the first signal path. A lower back plate electrode 322a of the first lower back plate 320a may be electrically connected with an upper back plate electrode 312b of the second upper back plate 310b through a wire 380 to form the second signal path.

In some possible embodiments, as shown in FIG. 3, according to an embodiment of the present disclosure, the first semiconductor diaphragm 330a of the first differential silicon-based microphone chip 300a is electrically connected with the second semiconductor diaphragm 330b of the second differential silicon-based microphone chip 300b, and at least one of the first semiconductor diaphragm 330a and the second semiconductor diaphragm 330b is electrically connected with a constant voltage source.

In the present embodiment, the first semiconductor diaphragm 330a of the first differential silicon-based microphone chip 300a is electrically connected with the second semiconductor diaphragm 330b of the second differential silicon-based microphone chip 300b, such that the semiconductor diaphragms 330 of the two differential silicon-based microphone chips 300 may have the same potential. That is, the criterion that the two differential silicon-based microphone chips 300 generate electrical signals may be unified.

Specifically, a wire 380 may be respectively electrically connected with the semiconductor diaphragm electrode 331a of the first semiconductor diaphragm 330a and the semiconductor diaphragm electrode 331b of the second semiconductor diaphragm 330b.

Optionally, the semiconductor diaphragms 330 of all the differential silicon-based microphone chips 300 may be electrically connected, such that the criterion that the differential silicon-based microphone chips 300 generate electrical signals may be unified.

In some possible embodiments, as shown in FIG. 1, the silicon-based microphone apparatus further includes a control chip 400.

The control chip 400 is located in the sound cavity 210 and is electrically connected with the circuit board 100.

One of the first upper back plate 310a and the second lower back plate 320b is electrically connected with one signal input terminal of the control chip 400. One of the first lower back plate 320a and the second upper back plate 310b is electrically connected with the other signal input terminal of the control chip 400.

In the present embodiment, the control chip 400 is used to receive two path signals output by the aforementioned differential silicon-based microphone chips 300 in which a physical noise removal has been completed, preform a secondary noise removal or the like on the two path signals, and then output them to the next-stage device or component.

Optionally, the control chip 400 is fixedly attached to the circuit board 100 through silica gel or red glue.

Optionally, the control chip 400 includes an application specific integrated circuit (ASIC) chip. Since the audio signal received by the control chip 400 has been subjected to physical noise reduction, the control chip 400 herein does not need to have a differential function, and a general control chip 400 may be used. For different application scenarios, the output signal of the ASIC chip may be a single-end signal, or may be a differential output signal.

In some possible embodiments, as shown in FIG. 2, the differential silicon-based microphone chip 300 includes a silicon substrate 340.

The first microphone structure 301 and the second microphone structure 302 are disposed to be stacked on one side of the silicon substrate 340.

The silicon substrate 340 has a via hole 341 for forming the back cavity 303 thereon, and the via hole 341 corresponds to both the first microphone structure 301 and the second microphone structure 302. A side far from the first microphone structure 301 and the second microphone structure 302 of the silicon substrate 340 is fixedly attached to the circuit board 100. The via hole 341 is communicated with the sound inlet hole 110.

In the present embodiment, the silicon substrate 340 supports the first microphone structure 301 and the second microphone structure 302. The via hole 341 for forming the back cavity 303 in the silicon substrate 340 may facilitate the entry of the sound waves into the differential silicon-based microphone chip 300. The sound waves may act on the first microphone structure 301 and the second microphone structure 302 respectively, such that the first microphone structure 301 and the second microphone structure 302 generate differential electrical signals.

In some possible embodiments, as shown in FIG. 2, the differential silicon-based microphone chip 300 further includes a patterned first insulating layer 350, a patterned second insulating layer 360 and a patterned third insulating layer 370.

The silicon substrate 340, the first insulating layer 350, the lower back plate 320, the second insulating layer 360, the semiconductor diaphragm 330, the third insulating layer 370 and the upper back plate 310 are disposed to be stacked sequentially.

In the present embodiment, the lower back plate 320 is separated from the silicon substrate 340 by the patterned first insulating layer 350, and the semiconductor diaphragm 330 is separated from the lower back plate 320 by the patterned second insulating layer 360, and the upper back plate 310 is separated from the semiconductor diaphragm 330 by the patterned third insulating layer 370, such that an electrical isolation is formed between the conductive layers, and a short circuit between the conductive layers may be avoided, and thus reduction of the signal accuracy may be avoided.

Optionally, each of the first insulating layer 350, the second insulating layer 360 and the third insulating layer 370 may be formed by forming an integrated film and then patterning the integrated film by an etching process to remove a portion of the integrated film corresponding to an area of the via hole 341 and an area for preparing an electrode.

It is to be noted that the silicon-based microphone apparatus in the above-mentioned embodiments of the present disclosure is illustrated by using a differential silicon-based microphone chip 300 implemented with a single diaphragm (for example, the semiconductor diaphragm 330), and two back electrodes (for example, the upper back plate 310 and the lower back plate 320) as an example. In addition to an arrangement of the single diaphragm and two back electrodes, the differential silicon-based microphone chip 300 may also be implemented with two diaphragms and a single back electrode, or other differential structures.

The inventors of the application considered that the multiple microphone chips in the silicon based microphone apparatus need to cooperate to achieve noise reduction. To this end, the present disclosure provides another following possible implementation for the electrical connection of the differential silicon-based microphone chips.

The silicon-based microphone apparatus according to an embodiment of the present disclosure further includes a differential control chip.

As shown in FIG. 4, in the at least two differential silicon-based microphone chips 300, first microphone structures 301 of all the silicon-based microphone chips 300 are sequentially electrically connected with each other and then electrically connected to one input terminal of the differential control chip 400. Second microphone structures 302 of all the silicon-based microphone chips 300 are sequentially electrically connected with each other and then electrically connected to the other input terminal of the differential control chip.

In the present embodiment, the first microphone structures 301 of the differential silicon-based microphone chips 300 are sequentially electrically connected with each other, and the second microphone structures 302 of the differential silicon-based microphone chips 300 are sequentially electrically connected with each other. When the sound is obtained, two audio signals with the same variation amplitude and opposite signs may be formed. Each audio signal is a superposed signal of a mixed electrical signal (including a sound electrical signal and a noise electrical signal) and a noise signal. When the two audio signals with the same variation amplitude and opposite signs are transmitted to the differential control chip for differential processing, the common mode noise may be reduced, the signal-to-noise ratio and the sound pressure overload point may be improved, thereby improving the sound quality.

The detailed structures of the differential silicon-based microphone chips 300 in the present embodiment are the same as those of the differential silicon-based microphone chips 300 provided in the above embodiments, and thus the description thereon is not repeated herein.

Based on the same inventive concept, an embodiment of the present disclosure further provides an electronic device including the silicon-based microphone apparatus described in any one of the described embodiments as above.

In the present embodiment, the electronic device may be a smart home product with large vibration such as a mobile phone, a TWS (True Wireless Stereo) headset, a robot vacuum cleaner, a smart air conditioner, a smart kitchen ventilator and the like. Since each of the electronic devices adopts the silicon-based microphone apparatus described in the foregoing embodiments, the principles and technical effects thereof may refer to the foregoing embodiments, and will not be repeated herein.

In some embodiments of the present disclosure, each of portion of the differential silicon-based microphone chips 300 has a back cavity 303 communicated with the respective sound inlet hole 110 in a one-to-one correspondence, such that external sound waves and the noise from the electronic device itself may act on the differential silicon-based microphone chips 300, and the differential silicon-based microphone chips 300 generate a mixed electrical signal of sound electrical signal and noise electrical signal. The back cavities 303 of other portion of the differential silicon-based microphone chips 300 may be closed by the circuit board 100, such that most of the external sound waves may be prevented from entering, the noise from the electronic device itself may act on those differential silicon-based microphone chips 300, and those differential silicon-based microphone chips 300 generate noise electrical signal. Further processing is performed on the mixed electrical signal and the noise electrical signal by a subsequent means, which may achieve noise reduction and improve the quality of the output audio signal.

In some embodiments of the present disclosure, the sound cavity 210 of the silicon-based microphone apparatus is formed by covering one side of the circuit board 100 with the shielding housing 200, and the separation member 500 separates the sound cavity 210 into sub-sound cavities 210 corresponding to back cavities 303 of at least portion of the differential silicon-based microphone chips 300 adjacent thereto. In this way, it is possible to effectively reduce the probability or intensity of sound waves entering the back cavity 303 of each differential silicon-based microphone chip 300 to continue to propagate in the sound cavity 210 of the silicon-based microphone apparatus, reduce the interference of the sound waves on other differential silicon-based microphone chips 300, and effectively improve the pickup accuracy of each differential silicon-based microphone chip 300, thereby improving the quality of audio signals output by the silicon-based microphone apparatus.

In the description of the present disclosure, it is to be understood that orientations or positional relationships indicated by the terms “center”, “upper”, “lower”, “front”, “rear”, “left”, “right”, “vertical”, “horizontal”, “top”, “bottom”, “inside”, “outside” and so on are based on the orientations or positional relationships shown in the accompanying drawings, which are only for convenience of describing the present disclosure and simplifying the description, rather than indicating or implying that the device or element referred necessarily has a particular orientation, needs to be constructed and operated in a particular orientation, and therefore, those terms should not be construed as a limitation to the present disclosure.

The terms “first” and “second” are used for describing purposes only, and should not be understood as indicating or implying relative importance or implying the number of technical features indicated. Thus, a feature defined by “first” or “second” may expressly or implicitly include one or more of such features. In the description of the present disclosure, unless stated otherwise, “plurality of” means two or more than two.

In the description of the present disclosure, it is to be noted that, unless otherwise expressly specified and limited, the terms “installed”, “connected” and “connection” should be understood in a broader sense, for example, a connection may be a fixed connection or a removable connection, or an integral connection; a connection may be directly connection, or indirectly connection through an intermediate medium, or may be an internal communication of two elements. The specific meanings of the above terms in the present disclosure may be understood by those ordinary skilled in the art according to specific situations.

In the description of the present specification, the particular features, structures, materials or characteristics may be combined in any suitable manner in any one or more of the embodiments or examples.

The above description is only some embodiments of the present disclosure, it is to be noted that, some improvements and modifications may also be made by those ordinary skilled in the art without departing from the principle of the present disclosure. These improvements and modifications should also be considered to be within the scope of the present disclosure.

1. A silicon-based microphone apparatus, comprising:
a circuit board provided with at least one sound inlet hole;
a shielding housing covering one side of the circuit board to form a sound cavity;
at least two differential silicon-based microphone chips disposed at the one side of the circuit board and located in the sound cavity, portion of the at least two differential silicon-based microphone chips each having a back cavity communicated with a respective one of the at least one sound inlet hole; and
a separation member located in the sound cavity and separating the sound cavity into sub-sound cavities corresponding to back cavities of at least portion of the differential silicon-based microphone chips adjacent thereto.

2. The silicon-based microphone apparatus of claim 1, wherein the separation member has one end extending toward the shielding housing and the other end extending at least to a side of the differential silicon-based microphone chip away from the circuit board.

3. The silicon-based microphone apparatus of claim 2, wherein the one end of the separation member is attached to the shielding housing; and/or
the other end of the separation member is attached to the one side of the circuit board.

4. The silicon-based microphone apparatus of claim 1, wherein the at least two differential silicon-based microphone chips include an even number of the differential silicon-based microphone chips, and the back cavity of one of every two of the differential silicon-based microphone chips is communicated with the sound inlet hole.

5. The silicon-based microphone apparatus of claim 4, wherein in every two of the differential silicon-based microphone chips, a first microphone structure of one of the differential silicon-based microphone chips is electrically connected with a second microphone structure of the other one of the differential silicon-based microphone chips, and a second microphone structure of the one of the differential silicon-based microphone chips is electrically connected with a first microphone structure of the other one of the differential silicon-based microphone chips.

6. The silicon-based microphone apparatus of claim 5, wherein each of the differential silicon-based microphone chips comprises an upper back plate, a semiconductor diaphragm and a lower back plate disposed to be stacked and spaced apart from each other,
the upper back plate and the semiconductor diaphragm constitute a main body of the first microphone structure, and the semiconductor diaphragm and the lower back plate constitute a main body of the second microphone structure, and
each of the upper back plate and the lower back plate has a portion provided with a plurality of airflow holes corresponding to the sound inlet hole.

7. The silicon-based microphone apparatus of claim 6, wherein every two of the differential silicon-based microphone chips include a first differential silicon-based microphone chip and a second differential silicon-based microphone chip,
a first upper back plate of the first differential silicon-based microphone chip is electrically connected with a second lower back plate of the second differential silicon-based microphone chip to form a first signal path, and
a first lower back plate of the first differential silicon-based microphone chip is electrically connected with a second upper back plate of the second differential silicon-based microphone chip to form a second signal path.

8. The silicon-based microphone apparatus of claim 7, wherein a first semiconductor diaphragm of the first differential silicon-based microphone chip is electrically connected with a second semiconductor diaphragm of the second differential silicon-based microphone chip, and at least one of the first semiconductor diaphragm and the second semiconductor diaphragm is electrically connected with a constant voltage source.

9. The silicon-based microphone apparatus of claim 1, further comprising a differential control chip,
in the at least two differential silicon-based microphone chips, first microphone structures of all the differential silicon-based microphone chips are sequentially electrically connected with each other and then electrically connected to one input terminal of the differential control chip, and second microphone structures of all the differential silicon-based microphone chips are sequentially electrically connected with each other and then electrically connected to the other input terminal of the differential control chip.

10. An electronic device comprising the silicon-based microphone apparatus of claim 1.
